(19) United States
(12) Patent Application Publication
(10) Pub. No.: US 2010/0155387 A1
(43) Pub. Date: Jun. 24, 2010

(54) HOTPLATE COOKER COVER FOR SAID COOKER AND METHOD FOR PRODUCTION OF THE HOTPLATE AND COVER

(75) Inventors: Jean-Marc Le Gall, Shanghai (CN); Gerald Fafet, Carrieres-sur-seine (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Eurokera S.N.C., Chateau-Thierry (FR)

(21) Appl. No.: 11/997,566

(22) PCT Filed: Jul. 27, 2006
(86) PCT No.: PCT/FR06/50753

§ 371 Date: Aug. 8, 2008

(30) Foreign Application Priority Data
Aug. 2, 2005 (FR) 0552420

(51) Int. Cl. H05B 3/68; B29C 47/02; B29C 65/02

(52) U.S. Cl. 219/465.1; 264/271.1; 156/85

(57) ABSTRACT

A hob for a fixed or portable cooker, the hob including an end face, an upper cooking surface, and a frame made of a plastic or a blend of plastics extending over at least part of the periphery of the hob. The frame cooperates with the cooking surface such that an internal wall of the frame is set back towards the center of the hob relative to the end face of the hob.

The present invention relates to a cooker with a hob and especially to a fixed cooker intended to be integrated into a bay provided in a work surface or on a stove, or to a portable cooker which can be moved manually and easily.

A cooker with a hob has in general a bottom and at least one side wall forming a base on the inside of which are positioned one or more heating elements, such as for example radiant or halogen heaters, and regulating means for varying the power of the latter. This cooker also has an upper cooking surface comprising in general a single hob, for example made of a glass-ceramic, on which may be positioned a saucepan, a frying pan or any other utensil capable of containing food to be reheated or cooked, or even on which food to be reheated or cooked may be positioned directly.

The present invention relates more particularly to a hob for a fixed or portable cooker, the said hob having an end face and an upper cooking surface and being provided with a frame made of a plastic or blend of plastics at least partly extending over the periphery of the said hob and thus cooperating with at least one edge or part of the edge of the said hob.

According to the invention, a cover may thus be produced, this cover having at least one hob and a frame made of a plastic or blend of plastics extending at least partly around the periphery of the said hob, the said cover being intended to cooperate with the base to which at least one heating element is fastened in order to allow the cooker to be produced.

It is known, in particular from French Patent Application FR 2 744 201, to produce the frame by encapsulating the constituent material of the frame around the hob inside a mould or by extruding the material using an extrusion head directly against at least one lower border of the hob and/or an end face of the hob.

In this prior art, the frame is placed so that its upper wall is flush with the cooking surface of the hob or even below the upper rim of the hob. Thus, the frame cooperates with the hob only at the end face of the hob and/or only at the lower rim of the hob.

A first drawback of this configuration is that it is difficult to produce a seal that remains reliable long term between the frame and the hob at the end face of the hob. Dirt may end up being lodged between the end face of the hob and the frame, or even liquid may be able to flow between the end face of the hob and the frame.

Another drawback of this configuration is that if liquid spills onto the hob, it can flow onto the frame and then onto the side walls of the cooker and finally onto the support on which the cooker is laid, whether this is a portable cooker or one in the bay in which a cooker is fitted.

Another drawback of this configuration is that no means for retaining a cooking vessel, or even food, exists on the hob.

One solution has been proposed in the prior art for glass-ceramic hobs. This consists in producing a second glass-ceramic hob in the form of an annular plate, having an outer contour substantially similar to the contour of the hob and a small width, and then in pressing this annular plate against the cooking surface so as to form a glass-ceramic protrusion over the entire perimeter of the hob.

This solution has several drawbacks: it is difficult to implement, as it is difficult to manufacture this annular plate and to fasten it to the hob; furthermore, it is expensive to implement for a series of identical hobs and even more so when several series of hobs having different dimensions are manufactured, as it is necessary to manufacture different annular plates for each series of hobs. Moreover, this solution does not make it possible to produce a rim over only part of the perimeter of the hob.

The encapsulation technique is complicated to implement as it requires production of at least two half-moulds and tooling that allows at least one of these half-moulds to move relative to the other in order to load the hob before the moulding and recovery of the hob, after the frame has been moulded, and for applying a high clamping pressure.

Furthermore, this technique is complicated to implement as the sealing must be sufficient inside the mould for the moulded material not to escape, but the applied clamping force must not be too high in order not to run the risk of breaking the hob.

Also, and above all, this technique requires different moulds to be produced each time that the frame or the hob is different, which increases the cost of industrialization.

The extrusion technique is not entirely satisfactory either, as it is difficult to obtain, with the current technique, an extruded profile that has the necessary mechanical properties and in particular the necessary rigidity.

Very often, manufacturers of cookers with a hob do not themselves manufacture the hobs but purchase them from suppliers.

It seems that, in order to lower the production costs of the cookers and in particular of the covers, one solution would consist in reducing the number of possible configurations of the hob, that is to say to reduce the number of standard hobs having different sets of length/width/thickness dimensions.

To make it possible to produce cookers that nevertheless have different aspects not only in terms of the base but also in terms of the cover itself, and thus to meet the expectations of the various cooker manufacturers, the solution therefore consists in offering manufacturers covers that include identical hobs, but different frames, namely frames that are longer or shorter, wider or narrower, thicker or thinner, in different colours, or with a different appearance, etc.

However, this solution comes up against a major difficulty when producing the frame, namely how to produce different series of frames without increasing the manufacturing cost.

The hob encapsulation technique, as explained above, cannot be used because of the cost of manufacturing the moulds and the implementation complexity of this technique.

Nor can the technique of extruding the frame around the hob be used in all cases, as it does not allow wide frames of sufficient rigidity to be produced.

Moreover, the cover formed at least by the hob and the frame must fulfil functions of different and complementary type.

Firstly, the cover must produce a rigid subassembly capable of withstanding the weight of cooking vessels and having suitable mechanical, chemical and thermal resistance.

Moreover, this cover must itself be impermeable and must also close off the base in a sealed manner. The subassembly formed by the hob and the frame must, on the one hand, be well sealed so that water, for example used for cleaning the visible surface of the hob, cannot penetrate into the cooker and risk creating a short circuit. On the other hand, from the hygiene standpoint, since such a hob is used for the preparation of food, it is necessary to avoid any risk of those regions that are difficult to access and difficult to clean becoming fouled so as not to cause germs to grow therein.

The object of the invention is to alleviate the drawbacks of the prior art and to provide an inexpensive and easily implementable solution for producing a rim around all or part of the upper border of a hob.

This rim therefore serves both as retaining rim, for keeping vessels or food on the hob and as an anti-spill rim for preventing liquids from spreading beyond the hob.

The present invention thus relates in its broadest sense to a hob (or cooking plate) for a fixed or portable (or movable) cooker, the said hob (or plate) having an end face and an upper cooking surface and being provided with a frame made of a plastic or blend of plastics extending over at least part of the periphery of the said hob, characterized in that the said frame cooperates with the said cooking surface in such a way that an internal wall of the frame is set back towards the centre of the said hob relative to the end face of this hob.

According to embodiments of the invention, the frame may have a parallelepipedal shape in cross section.

An external wall of the frame is then preferably positioned in the extension of the end face of the hob or set back towards the centre of the said hob relative to the end face of this hob.

According to other embodiments of the invention, the frame may have, in cross section:
an r shape;
a T shape;
a + shape;
a J shape;
a U shape; or
an F shape.

In certain embodiments, in particular the last three, at least one edge of the said hob is set into the frame.

In certain embodiments, the frame forms only all or part of the perimeter of an upper cooking surface of the cooker, whereas in other embodiments, in particular the last one, the frame forms all or part of the perimeter of an upper cooking surface of the cooker and all or part of at least one side wall of this cooker.

It is also possible to combine several embodiments for the same frame and to ensure cooperation between an edge portion of the hob and the frame according to one embodiment and cooperation between another edge portion of the hob and the frame according to another embodiment.

The term “edge” within the meaning of the present invention denotes a volume defined at one of its ends by the upper border of the hob, the end face of the hob and the lower border of the hob, whereas the term “border” denotes an area, either the upper or lower area, bounded at one end by the end face of the hob.

The frame has a thickness e of at least one 1 mm and preferably at least 2 mm above the said cooking surface of the hob, so as to form the retaining and/or anti-spill protrusion, but it may also have a thickness of 3 mm or even 4 mm or even more, so as to be sufficiently effective.

For this projection to be sufficiently effective, the frame preferably has a sufficient width 1, of at least 2 mm and preferably at least 4 mm, set back towards the centre of the said hob relative to the end face of this hob.

The hob may also include a seal and especially a seal for providing adhesion and/or sealing, interposed between one wall of the frame and the adjacent surface of the hob and more particularly between a surface of the frame adjacent to the cooking surface of the hob and this cooking surface.

The hob according to the invention may also include control means. These control means are then preferably integrated into the said frame.

Moreover, the constituent material of the frame preferably has a heat resistance temperature above 100° C. and preferably above 120° C., that is to say its properties, especially its mechanical integrity, are not greatly modified at such a temperature, so that there is no risk of the frame coming off, even when a heavy cooking vessel is being used.

The hob is preferably a glass-ceramic hob, but it may also be made of a plastic, for example a polyvinyl-based plastic, or made of glass, particularly made of toughened glass.

The present invention also relates to a process for manufacturing a hob for a fixed or portable (or movable) cooker, in particular a process for manufacturing a hob according to the invention, the said hob (or plate) having an end face and an upper cooking surface and being provided with a frame made of a plastic or blend of plastics extending at least partly around the periphery of the said hob, the process being characterized in that the said frame is manufactured by prior moulding of the said frame and then bonding of the frame to the hob or by in situ extrusion of the frame onto the hob or by in situ encapsulation of the frame on the hob, and is manufactured so as to cooperate with the said cooking surface in such a way that an internal wall of the frame is set back towards the centre of the said hob relative to the end face of this hob.

According to one particular method of implementing this process, the hob and the said frame are manufactured separately, the said hob being inserted into a groove in the said frame when the latter is hot and the said frame being fastened to the said hob by the shrinking of the constituent material of the said frame.

Within the context of the present invention, a groove is formed by at least two approximately plane and intersecting walls of the frame, or even by three plane walls intersecting in pairs, two walls also being approximately parallel. These plane walls are intended to receive, on the one hand, at least one part of the end face of the hob and, on the other hand, the upper and/or lower border of the hob.

The present invention also relates to a fixed or portable cooker that includes at least one hob according to the invention.

This cooker may include a seal interposed between one wall of the frame and an adjacent wall of the cooker.

It is an object of the invention also to alleviate the drawbacks of the prior art and to provide an acceptable solution for the production of covers with identical hobs and different frames for a reasonable cost.

The present invention thus also relates to a process for manufacturing a cover comprising at least one hob (or cooking plate) and one frame made of a plastic or blend of plastics extending at least partly around the periphery of the said hob, the said cover being intended to cooperate with a base to which at least one heating element is fastened, in order to make it possible to produce a cooker, especially a portable (or movable) cooker, having a bottom, at least one side wall and an upper cooking surface, characterized in that the said hob and the said frame are manufactured separately, the said hob being inserted into a groove in the said frame when the latter is hot and the said frame being fastened to the said hob by the shrinking of the constituent material of the said frame.

The process according to the invention thus relies on the use of one property of plastics, known elsewhere, namely the shrinkage of the material during moulding, so as to propose a method of assembly and of particular cooperation between the hob and the frame.

Thus, the hob is inserted into a groove in the frame when the latter is hot, and the frame, upon subsequently cooling, applies surface pressure to the adjacent wall of the hob.

It is possible that, with certain plastics or with certain blends of plastics, this pressure is accompanied by adhesion of the constituent material of the frame to the adjacent surface of the hob.

Thus, if an analysis is carried out, it is possible to observe either that the frame is only mechanically fitted onto the hob or that the frame is mechanically fitted onto the hob and there is also adhesion of the material of the frame to the adjacent surface of the hob.

Moreover, it is possible that, with certain plastics or certain blends of plastics, it may be necessary at certain points to provide at least one adhesive between the hob and the frame, or to provide a seal.

However, with certain plastics or certain blends of plastics, it is not necessary to provide adhesive or a seal between the hob and the frame.

The frame is manufactured by moulding, but this manufacture is less expensive than in the case of encapsulation since the moulds are simpler. Direct moulding of the frame is also simpler to implement than encapsulation, since the clamping pressures for the half-moulds are lower and, of course, there is no longer any risk of breaking the hob when moulding the frame since the hob is not present in the mould.

In one method of implementing the process, the frame is not cooled between the point when it is manufactured and the point when it is fastened to the said hob. In this method, the hob is thus preferably inserted into the groove in the frame within a few minutes following the manufacture of the frame in order not to keep the frame hot for too long.

In another method of implementing the process, the said frame is cooled between the point when it is manufactured and the point when it is fastened to the said hob. In this other method, the frame is thus heated up to a temperature allowing the hob to be inserted into the groove in the frame, and then the frame is cooled when the hob is in the groove. This method is of value as it makes it possible, by providing a stock of suitable hot frames, to rapidly protect the end face of the hob, right from manufacture of the hob, so as to avoid any direct impact between the end face and to prevent the subsequent propagation of cracks.

Moreover, the cooperation between the hob and the frame at the edge of the hob is represented by two main embodiments.

In one embodiment, the said frame is fastened to the said hob so as to set in at least one edge of the said hob, that is to say to set in an upper border, an end face and a lower border of the hob.

In the other embodiment, the said frame is fastened to the said hob so as not to extend vertically beyond the upper surface of the said hob, that is to say the frame is adjacent only to the end face and to the lower border of the hob.

These two embodiments may be used to produce two series of different covers, but may also be used on the same cover. For example in the case of a rectangular hob, the longitudinal edges of the cover may be formed according to one embodiment and the transverse edges of the cover according to the other embodiment.

The present invention also relates to a cover comprising at least one hob (or plate) and a frame that extends at least partly around the periphery of the said hob, the said cover being intended to cooperate with a base to which at least one heating element is fastened, in order to make it possible to produce a cooker, especially a portable (or movable) cooker, the said cover being obtained by implementing the process according to the invention.

All the side walls of the cooker (or only some of them) may form an integral part either of the base of the cooker or of the cover.

Thus, either the frame forms all or part only of the said upper cooking surface, or the frame forms all or part of the said upper cooking surface and all or part of at least one side wall of the cooker.

Moreover, four particular embodiments of the frame according to the invention have been developed:
1) the frame has a U shape in cross section, at least one edge of the said hob being set into this shape;
2) the frame has an L shape in cross section, the base of the L being positioned opposite the end face of the said hob and the vertical branch of the L being positioned under a lower border of the hob;
3) the frame has an F shape in cross section, an edge of the said hob being set into the two horizontal branches of the F so that the trunk part of the F, which is located between the two branches, is positioned opposite the end face of the hob and so that the lower end of the trunk of the F forms at least part of the side wall;
4) the frame has an r shape in cross section, the upper end of the trunk of the r being positioned opposite the end face of the said hob, the lower end of the trunk of the r forming at least part of the side wall and the branch of the r being positioned under a lower border of the hob.

It is also possible to combine several embodiments for the same frame and for there to be cooperation between one edge portion of the hob and the frame according to one embodiment and cooperation between another edge portion of the hob and the frame according to another embodiment.

The cover according to the invention may furthermore include control means, these control means then being preferably integrated into the frame.

The present invention also relates to a cooker, especially a portable cooker, having a bottom, at least one side wall and an upper cooking surface, the said cooker having a base to which at least one heating element is fastened and having a cover according to the invention.

The base of the cooker may for example have, when seen from below, a circular, triangular, rectangular, square, trapezoidal or other shape, and the cover closing off the base may have, when seen from above, a circular, triangular, rectangular, square, trapezoidal or other shape, preferably identical to that of the horizontal section of the base.

The present invention also relates to the use of a cover according to the invention for sealing, in a liquid-tight manner, a base to which at least one heating element is fastened so as to form a cooker.

The present invention also relates to the use of several covers according to the invention, having different dimensions, each so as to seal off, in a liquid-tight manner, a base to which at least one heating element is fastened so as to form cookers having different dimensions, the dimensions of the said hobs being the same.

Advantageously, the present invention thus proposes a particular frame configuration for the hob, making it possible to produce, over all or at least part of the upper perimeter of the hob, a retaining and/or anti-spill rim.

Advantageously, the present invention also proposes a process for manufacturing a cover for a cooker, which is simple and inexpensive to implement, in particular for short production runs, when the required configurations change from one run to another.

The present invention makes it possible in particular to offer manufacturers of cookers, produced in short production runs, covers having different configurations, these covers however incorporating identical hobs manufactured in very long production runs.

Also advantageously, since the hob is preferably chosen to be made of glass-ceramic so as not to heat up in its part in contact with the frame, there is then no risk of the hob separating as a result of the loss of some mechanical property of the frame by heat propagation. However, if the hob is not made of glass-ceramic, it is necessary to choose the constituent material of the frame so that it does not soften at the operating temperatures of the cooker in order to prevent the hob from separating from the frame.

The present invention will be better understood on reading the detailed description below of non-limiting illustrative examples and from the figures appended hereto:

FIG. 1 illustrates a schematic view, in perspective, of a portable cooker according to the invention;

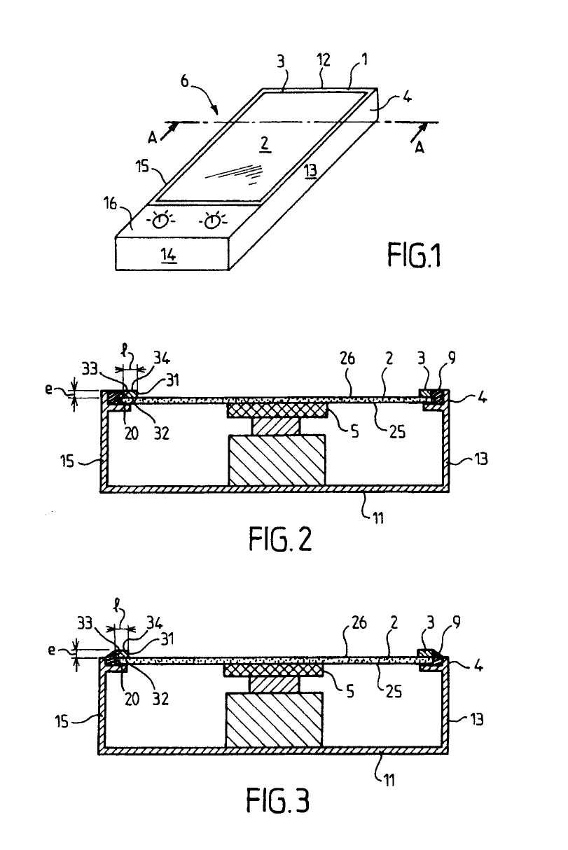

FIG. 2 illustrates a view, in cross section on AA of FIG. 1, of an embodiment with a parallelepipedal frame with external edges set back relative to the end face of the hob;

FIG. 3 illustrates a view, in cross section on AA of FIG. 1, of an embodiment with a parallelepipedal frame and external edges flush with the end face of the hob;

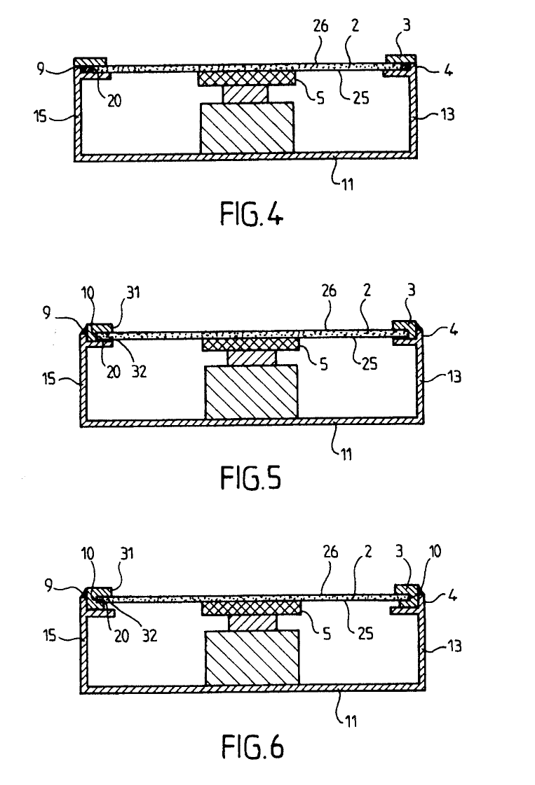

FIG. 4 illustrates a view, in cross section on AA of FIG. 1, of an embodiment with a parallelepipedal frame and with external edges that extend beyond the end face of the hob;

FIG. 5 illustrates a view, in cross section on AA of FIG. 1, of an embodiment with an r-shaped frame;

FIG. 6 illustrates a view, in cross section on AA of FIG. 1, of an embodiment with a U-shaped frame, corresponding to a first embodiment of the cover of the cooker according to the invention;

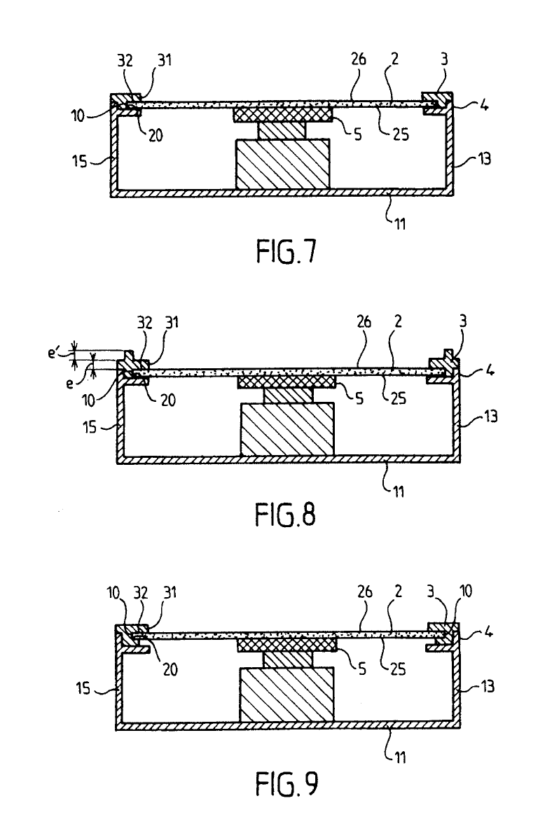

FIG. 7 illustrates a view, in cross section on AA of FIG. 1, of an embodiment with a T-shaped frame;

FIG. 8 illustrates a view, in cross section on AA of FIG. 1, of an embodiment with a +-shaped frame;

FIG. 9 illustrates a view, in cross section on AA of FIG. 1, of an embodiment with a J-shaped frame;

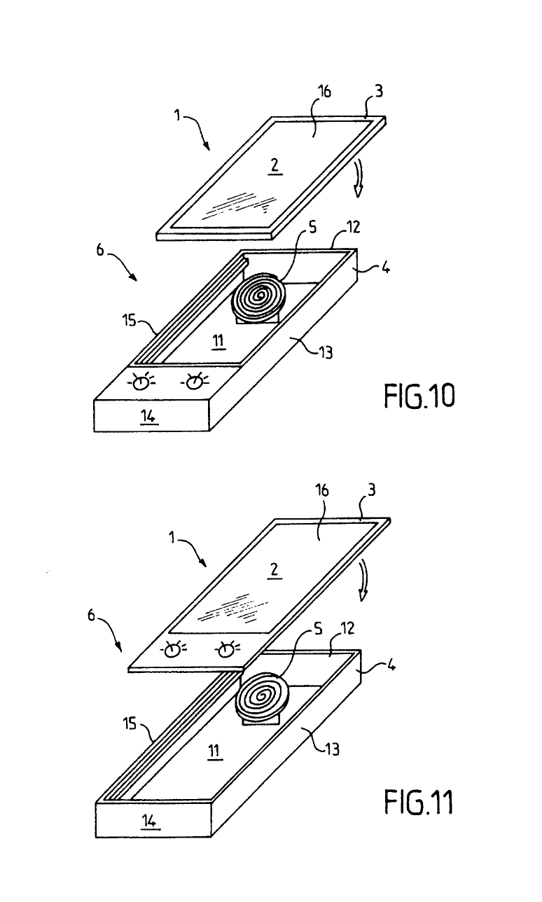

FIG. 10 illustrates an exploded view of the cooker of FIG. 1;

FIG. 11 illustrates a schematic exploded view of an embodiment of the cooker of FIG. 1 in which the frame of the cover incorporates means for controlling the cooker;

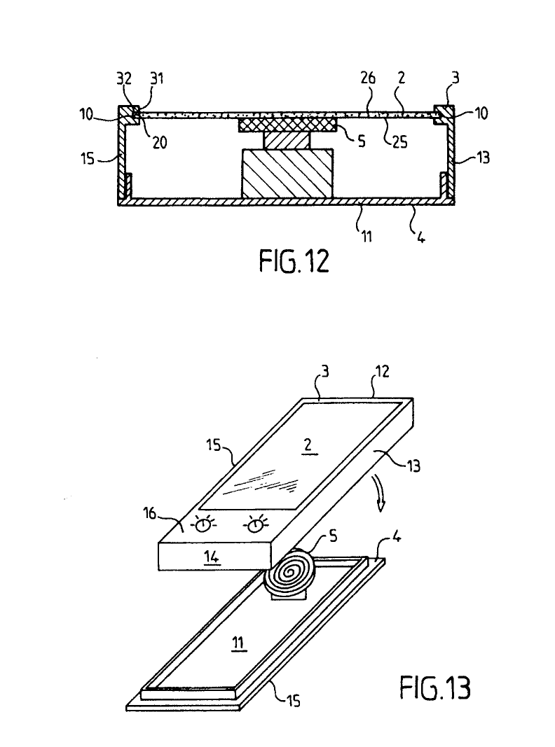

FIG. 12 illustrates a cross-sectional view at the heating element of an embodiment with an F-shaped frame, corresponding to a third embodiment of the cover of the cooker according to the invention;

FIG. 13 illustrates an exploded schematic view of the cookers of FIGS. 12 and 15;

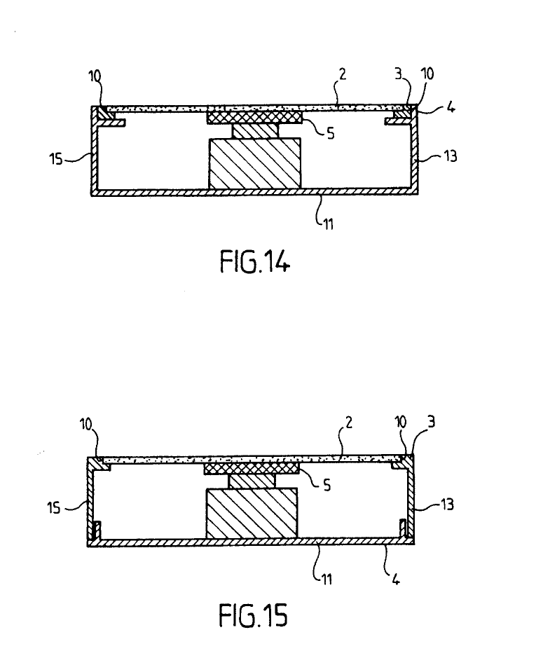

FIG. 14 illustrates a view, in cross section on AA of FIG. 1, of an embodiment with an L-shaped frame corresponding to a second embodiment of the cover of the cooker according to the invention;

FIG. 15 illustrates a cross-sectional view at the heating element of an embodiment with an r-shaped frame corresponding to a fourth embodiment of the cover of the cooker according to the invention;

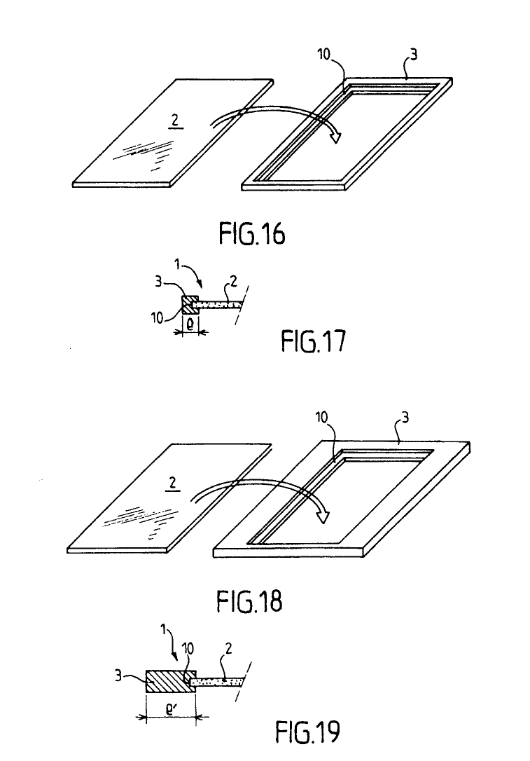

FIG. 16 illustrates the essential step of forming the cover according to the invention with a first type of frame, having narrow walls;

FIG. 17 illustrates a partial cross-sectional view of the cover after the formation step illustrated in FIG. 16;

FIG. 18 illustrates the essential step of forming the cover according to the invention with a second type of frame, having wide walls; and

FIG. 19 illustrates a partial cross-sectional view of the cover after the formation step illustrated in FIG. 18.

It should be pointed out that the various elements shown in these figures have not been drawn strictly to scale so as to make them easier to examine.

FIG. 1 illustrates one example of an embodiment of a cooker (6) according to the invention, having a base (4) and a cover (1). The cooker illustrated here thus has a parallelepipedal general shape, both in horizontal and in vertical cross section, but any other shape is conceivable.

The cooker illustrated here is a portable cooker, which may be positioned for example on a worktop or on a meal table and can be moved manually. However, the present invention also applies to “built-in” cookers that are fitted into a bay provided in a worktop or in a stove and which, once fitted and fastened, can no longer be moved.

The cover (1) cooperates with the base (4) in order to produce the cooker, that is to say the cover (1) closes off the base (4) in order to form a box, preferably sealed against liquids for safety reasons. This cooperation may be of various types—in particular, it may involve fastening using screws, clip-fastening or adhesive bonding.

The cooker thus closed has a bottom (11), side walls (12, 13, 14, 15), four in number here, and an upper cooking surface (16).

The cover (1) forms at least the cooking surface (16) and includes at least one hob (2) and a frame (3) made of a plastic or blend of plastics that extends at least partly around the periphery of the said hob.

The base (4) of the cooker incorporates at least the bottom (11) and forms a housing to which at least one heating element (5) is fastened, as may be seen in particular in FIGS. 2 to 9, which heating element is in contact or virtually in contact with a lower surface (25) of the hob (2), this lower surface being positioned facing towards the inside of the cooker when the base is closed off by the cover.

The upper surface of the hob (2), which is positioned facing the outside of the cooker when the base is closed off by the cover, constitutes a cooking surface (26).

The hob (2) also has an end face (20) positioned here approximately vertically.

To simplify matters, only a single heating element is shown here, but there may be two, three, four or more of them.

The heating elements may be radiant or halogen elements and/or at least one gas burner and/or at least one induction heating coil.

Moreover, again to simplify matters, the supply for the heating element has not been illustrated.

The hob (2) here is a glass-ceramic plate and the heating element is a radiant element.

In the figures, the cover (1) comprises a single hob (2) and a single frame (3) extending all around the periphery of the said hob.

The side walls (12, 13, 14, 15) of the cooker may be completely integrated into the base (4), as illustrated in FIGS. 1 to 11, or completely integrated into the cover (1), as illustrated in FIGS. 12, 13 and 15. It is also possible for certain side walls, such as for example the front and rear walls, to be integrated into the base and the others, such as for example therefore the left and right walls, integrated into the cover, or else for certain side walls, or even all the side walls, to be integrated in the lower portion into the base and in the upper portion integrated into the cover.

The frame (3) cooperates with the said cooking surface (26) of the hob (2) in such a way that an internal wall (31) of the frame, that is to say a wall turned towards the centre of the cooker, is set back towards the centre of the said hob (2) relative to the end face (20) of this hob and therefore set back towards the centre of the cooker.

In the embodiments illustrated in FIGS. 2 to 9 and 12, the frame (3) has a thickness e at the cooking surface (26).

This thickness e is preferably at least 1 or 2 mm and in particular 3, or even 4 or more, above the said cooking surface (26) of the hob, so as to be able to form a projection, preferably with straight edges, in order to retain cooking vessels and to prevent them from overturning. This shoulder also makes it possible to prevent a liquid or food overturned on the hob from getting beyond the frame.

Again in the embodiments illustrated in FIGS. 2 to 9 and 12, the frame (3) also has a width 1 of at least 2 mm and in particular 3, or even 4 mm or more, set back towards the centre of the said hob (2) relative to the end face (20) of this hob. This width is not necessarily constant all around the frame.

Moreover, a sealing and/or bonding seal (not shown) may be interposed between a wall of the frame (3) and the adjacent surface of the hob (2).

Moreover, a sealing and/or bonding seal (9) may be interposed between a wall of the frame (3) and an adjacent wall (12, 13, 14, 15) of the cooker.

In one embodiment of the hob (2), illustrated in FIGS. 2 to 4, the frame (3) has a parallelepipedal shape in cross section, more precisely a rectangular shape.

In all these embodiments, the internal wall (31) of the frame is set back towards the centre of the said hob (2), but the external wall (33) of the frame, that is to say the wall directed away from the centre of the cooker and from the said hob (2), has various configurations, it being possible for this external wall (33) of the frame (3) to be positioned:
set back towards the centre of the said hob (2) relative to the end face (20) of this hob, as illustrated in FIG. 2; or
in the vertical extension of the end face (20) of the hob (2), as illustrated in FIG. 3; or
projecting horizontally beyond the end face of the hob away from the centre of the said hob (2), as illustrated in FIG. 4.

In the latter configuration, the frame may thus cover an upper edge of the side walls (13, 15) of the cooker.

In one embodiment of the hob (2), illustrated in FIG. 5, the frame (3) has an r shape in cross section and is therefore positioned in such a way that the trunk of the r is adjacent to the end face of the hob and the branch of the r rests on the border of the cooking surface (26).

In one embodiment of the hob (2), illustrated in FIG. 7, the frame (3) has a T shape in cross section and is then positioned in such a way that the trunk of the T is adjacent to the end face of the hob and one branch of the T rests on the border of the cooking surface (26). The other branch of the T can then rest on an upper edge of a side wall (13, 15) of the cooker, this edge being approximately level with the cooking surface (26).

The branches of the T need not be symmetrical with respect to the trunk and are not necessarily of the same length or of the same thickness.

In one embodiment of the hob (2), illustrated in FIG. 8, the frame (3) has a + shape in cross section and is then positioned in such a way that the lower part of the trunk of the + shape is adjacent to the end face of the hob and one branch of the + shape rests on the border of the cooking surface (26). The other branch of the + shape can then rest on an upper edge of a side wall (13, 15) of the cooker, this edge being approximately level with the cooking surface (26).

The embodiment illustrated in FIG. 8 thus has two projections.

The upper part of the trunk of the +, which lies above the branches, then forms an additional retaining projection, or when the branch of the + that is adjacent to the border of the cooking surface has a small thickness, it forms the main retaining projection. This configuration is possible in particular when the branch of the +adjacent to the border of the cooking surface is made in the form of a sealing lip with a thickness e smaller than the thickness e′ of the additional retaining projection.

The branches of the + shape therefore need not be symmetrical relative to the trunk and are not necessarily of the same height or of the same width.

In one embodiment of the hob (2), illustrated in FIGS. 6, 9 and 12, at least one edge of the said hob (2) is set into the frame (3), preferably two edges, in particular two opposed edges relative to the centre of the hob, or even all the edges of the hob, are set into the said frame.

In one embodiment of the hob (2), illustrated in FIG. 6, the frame (3) has a U shape in cross section and is then positioned in such a way that the base of the U is adjacent to the end face of the hob, the upper branch of the U rests on the border of the cooking surface (26) and the lower branch of the U is positioned against the lower surface (25) of the hob.

The branches of the U need not be symmetrical relative to the base and are not necessarily of the same length or of the same width.

In one embodiment of the hob (2), illustrated in FIG. 9, the frame (3) has a J shape in cross section and is then positioned in such a way that the trunk of the J is adjacent to the end face of the hob, one upper branch of the J rests on the border of the cooking surface (26) and the lower branch of the J is positioned against the lower surface (25) of the hob. The other upper branch of the J can then rest on an upper edge of a side wall (13, 15) of the cooker, this edge being approximately level with the cooking surface (26).

The branches of the J need not be symmetrical relative to the trunk and are not necessarily of the same length or of the same thickness.

In one embodiment of the hob (2), illustrated in FIG. 12, the frame (3) has an F shape in cross section and is then positioned in such a way that the trunk of the F is adjacent to the end face of the hob, the upper branch of the F rests on the border of the cooking surface (26) and the lower branch of the F is positioned against the lower surface (25) of the hob.

The branches of the F thus need not be symmetrical and are not necessarily of the same length or of the same thickness.

In all the embodiments illustrated in FIGS. 2 to 9 and 12, the frame (3) is located around the entire perimeter of the upper cooking surface (16) of the cooker. This frame (3) could also be located only around part of the perimeter of the upper cooking surface (16) of the cooker, such as for example around the front and rear parts, or else around the side parts.

In the embodiment illustrated in FIG. 12, the frame (3) is located around the entire perimeter of the upper cooking surface (16) of the cooker and forms all the side walls (12, 13, 14, 15) of this cooker.

In all the embodiments, the hob (2) may include control means, illustrated here by two knobs. These control means are then preferably integrated into the frame (3), as may be seen for example in FIGS. 10, 11 and 13.

In a first embodiment of the frame (3), illustrated in FIG. 6, the frame (3) has a U shape in cross section and is positioned in such a way that the base of the U is adjacent to the end face of the hob (2) and the branches of the U are adjacent to the upper and lower borders of the hob, so that the edge of the said hob is set thereinto.

In this first embodiment, the top of the frame (3) lies above the upper surface of the hob (2).

In a second embodiment of the frame (3), illustrated in FIG. 14, the frame (3) has an L shape in cross section and is positioned in such a way that the vertical branch of the L is adjacent to the end face of the hob (2) and the horizontal lower base of the L is adjacent to the lower border of the hob and is beneath the said hob.

In this second embodiment, the top of the frame (3) is approximately flush with the upper surface of the hob (2).

In a third embodiment of the frame (3), illustrated in FIG. 12, the frame (3) has an F shape in cross section and is positioned in such a way that the upper part of the trunk of the F, which lies between the two parallel branches, is positioned facing the end face of the hob (2) and the two parallel branches of the F are adjacent to the upper and lower borders of the hob, so that the edge of the said hob is set thereinto. The trunk of the F then forms the side walls (12, 13, 14, 15) and this trunk cooperates in its lower part with the bottom (11) of the base (4).

In a fourth embodiment of the frame (3), illustrated in FIG. 15, the frame (3) has an r shape in cross section and is positioned in such a way that the upper part of the trunk of the r, which lies above the horizontal branch, is positioned facing the end face of the hob (2) and the horizontal branch of the r is adjacent to the lower border of the hob and is under the said hob. The trunk of the r then forms the side walls (12, 13, 14, 15), and this trunk cooperates in its lower part with the bottom (11) of the base (4).

FIG. 16 illustrates the essential step of the process for manufacturing a frame according to the invention in order to produce the first embodiment of the frame. With the said hob (2) and the said frame (3) having been manufactured separately, the hob (2) is then inserted into a groove (10) in the said frame (3) while the latter is hot.

The operation of fastening the frame (3) to the said hob (2) after the constituent material of the frame (3) has cooled and shrunk is illustrated in FIG. 17.

In FIGS. 16 and 17, the frame (3) has a relatively narrow wall of width 1 corresponding approximately to twice the thickness of the hob (2).

In FIGS. 18 and 19, the frame (3) has a relatively wide wall of width 1′, corresponding here to approximately six times the thickness of the hob (2).

FIG. 18 illustrates the step of inserting the hob (2) into the groove (10) in the wide-walled frame (3) and FIG. 19 illustrates the fastening of the wide-walled frame (3) to the said hob (2) after the constituent material of the frame (3) has cooled and shrunk.

After cooling, the cover (1) may be attached to the base (4) using appropriate means.

Of course, it is possible for the frame (3) to have many different widths.

The frame (3) is made of a material having a linear shrinkage coefficient sufficient to allow the invention to be implemented, in particular greater than 0.25, or greater than 0.5, or greater than 0.75 or even greater than 1.

In all the embodiments, the cover (1) may include control means, illustrated here by two knobs. These control means are then preferably integrated into the frame (3), as may be seen for example in FIGS. 10, 11 and 13.

The process for manufacturing covers according to the invention is particularly useful for the manufacture of several production runs of covers (1) when the covers have different dimensions from one run to another.

It is then possible for the cookers (6) incorporating these covers to have different dimensions, whereas the dimensions of the hobs (2) are the same.

The present invention has been described above by way of example. Of course, a person skilled in the art would be capable of producing various alternative embodiments of the invention without thereby departing from the scope of the patent as defined by the claims.

1-43. (canceled)

44. A hob or cooking plate for a fixed or movable cooker, comprising:
an end face;
an upper cooking surface; and
a frame made of a plastic or a blend of plastics extending over at least part of the periphery of the plate,
wherein the frame cooperates with the cooking surface such that an internal wall of the frame is set back towards the center of the plate relative to the end face of the plate.

45. A hob according to claim 44, wherein the frame has a parallelepipedal shape in cross section.

46. A hob according to claim 45, wherein an external wall of the frame is positioned in an extension of the end face of the plate or set back towards the center of the plate relative to the end face of the plate.

47. A hob according to claim 44, wherein the frame has an r shape in cross section.

48. A hob according to claim 44, wherein the frame has a T shape in cross section.

49. A hob according to claim 44, wherein the frame has a + shape in cross section.

50. A hob according to claim 44, wherein at least one edge of the plate is set into the frame.

51. A hob according to claim 50, wherein the frame has a J shape in cross section.

52. A hob according to claim 50, wherein the frame has a U shape in cross section.

53. A hob according to claim 50, wherein the frame has an F shape in cross section.

54. A hob according to claim 44, wherein the frame has a thickness of at least 1 mm or at least 2 mm above the upper cooking surface.

55. A hob according to claim 44, wherein the frame has a width of at least 2 mm or at least 4 mm set back towards the center of the plate relative to the end face of the plate.

56. A hob according to claim 44, further comprising a seal interposed between one wall of the frame and an adjacent surface of the plate.

57. A hob according to claim 44, wherein the frame forms all or part of the perimeter of the upper cooking surface.

58. A hob according to claim 44, wherein the frame forms all or part of the perimeter of the upper cooking surface and all or part of at least one side wall.

59. A hob according to claim 44, further comprising a controller.

60. A hob according to claim 59, wherein the controller is integrated into the frame.

61. A hob according to claim 44, wherein constituent material of the frame has a heat resistance temperature above 100° C. or above 120° C.

62. A hob according to claim 44, made of glass-ceramic.

63. A fixed or movable cooker comprising at least one hob according to claim 44.

64. A cooker according to claim 63, further comprising a seal interposed between one wall of the frame and an adjacent wall of the cooker.

65. A process for manufacturing a hob or cooking plate for a fixed or movable cooker, the plate including an end face, an upper cooking surface, and a frame made of a plastic or a blend of plastics extending at least partly around the periphery of the plate, the process comprising:
prior molding the frame and then bonding the frame to the plate or by in situ extrusion of the frame onto the plate or by in situ encapsulation of the frame on the plate,
wherein the frame is manufactured so as to cooperate with the cooking surface such that an internal wall of the frame is set back towards the center of the plate relative to the end face of the plate.

66. A process for manufacturing a hob according to claim 65, wherein the plate and the frame are manufactured separately, the plate being inserted into a groove in the frame when the frame is hot and the frame being fastened to the plate by shrinking of constituent material of the frame.

67. A process for manufacturing a cover including at least one hob or cooking plate and one frame made of a plastic or a blend of plastics extending at least partly around the periphery of the hob, the cover configured to cooperate with a base to which at least one heating element is fastened, to produce a cooker, including a bottom, at least one side wall, and an upper cooking surface, wherein the plate and the frame are manufactured separately, the plate being inserted into a groove in the frame when the frame is hot and the frame being fastened to the plate by shrinking constituent material of the frame.

68. A process according to claim 67, wherein the frame is not cooled between a point when the frame is manufactured and a point when the frame is fastened to the plate.

69. A process according to claim 67, wherein the frame is cooled between a point when the frame is manufactured and a point when the frame is fastened to the plate.

70. A process according to claim 67, wherein the frame is fastened to the plate so as to set in an edge of the plate.

71. A process according to claim 67, wherein the frame is fastened to the plate so as not to extend vertically beyond the upper surface of the hob.

72. A cover comprising:
at least one hob or cooking plate; and
a frame that extends at least partly around the periphery of the plate,
the cover configured to cooperate with a base to which at least one heating element is fastened, to produce a cooker, the cover obtained by the process according to claim 67.

73. A cover according to claim 72, wherein the frame forms all or part of the perimeter of the upper cooking surface.

74. A cover according to claim 72, wherein the frame forms all or part of the perimeter of the upper cooking surface and all or part of at least one side wall.

75. A cover according to claim 72, wherein the frame has a U shape in cross section.

76. A cover according to claim 72, wherein the frame has an L shape in cross section.

77. A cover according to claim 72, wherein the frame has an F shape in cross section.

78. A cover according to claim 72, wherein the frame has an r shape in cross section.

79. A cover according to claim 72, further comprising a controller.

80. A cover according to claim 79, wherein the controller is integrated into the frame.

81. A cover according to claim 72, wherein constituent material of the frame has a heat resistance temperature above 100° C. or above 120° C.

82. A cover according to claim 72, wherein the hob is a glass-ceramic hob.

83. A cooker comprising:
a bottom;
at least one side wall;
an upper cooking surface; and
a base to which at least one heating element is fastened and having a cover according to claim 72.

84. A cooker according to claim 83, further comprising a seal interposed between one wall of the frame and an adjacent wall of the cooker.

85. Use of a cover according to claim 72 for sealing, in a liquid-tight manner, a base to which at least one heating element is fastened so as to form a cooker.

86. Use of plural covers according to claim 72, having different dimensions, each so as to seal off, in a liquid-tight manner, a base to which at least one heating element is fastened so as to form cookers having different dimensions, the dimensions of the hobs being the same.
